(19) United States
(12) Patent Application Publication
(10) Pub. No.: US 2017/0193195 A1
(43) Pub. Date: Jul. 6, 2017

(54) CLINICAL STUDY TREND ANALYZER

(71) Applicant: CERNER INNOVATION, INC., KANSAS CITY, KS (US)

(72) Inventors: Satya Krishna Pillarisetty, Bangalore (IN); Krishna Kumar, Bangalore (IN); Kevin Power, Kansas City, MO (US); Mahesh Vilas Kotekar, Bangalore (IN); Benjamin Birnbaum, Prairie Village, KS (US); Pradeep Premakumar, Bangalore (IN); Thampuraj Dharmamoorthy, Bangalore (IN)

(21) Appl. No.: 15/060,199

(22) Filed: Mar. 3, 2016

(30) Foreign Application Priority Data
Dec. 30, 2015 (IN) 4317-DEL-2015

(51) Int. Cl. G06F 19/00

(52) U.S. Cl. CPC G06F 19/363; G06F 19/324; G06F 19/322

(57) ABSTRACT

Methods, systems, and computer-readable media are provided for computer-based healthcare information to monitor medical parameters of multiple patients in clinical study and create a record of patients in a clinical study who satisfy certain clinical parameters. The record of clinical study patients can be used to analyze medical trends occurring in a clinical study such that adjustments can be made to the study as needed. The medical trends may also be used to make healthcare warnings and recommendations for one or more clinical study patients to prevent the patients from falling out of the clinical study for not meeting medical parameters.

### BACKGROUND

This application filed at the United States Patent and Trademark Office claims a priority benefit under 35 U.S.C. §119 to co-pending Indian Provisional Application No. 4317-DEL-2015, filed in India on 30 Dec. 2015 and entitled “Clinical Trial Patient Retention and Health Maintenance System” the entirety of which is incorporated by reference herein.

According to the World Health Organization, a clinical trial is any research study that prospectively assigns human participants or groups of humans to one or more health-related interventions, such as a drug or medical device, to evaluate the effects on health outcomes. Clinical trials are conducted by government health agencies, researchers affiliated with a hospital or university medical program, independent researchers, private industry or a combination thereof.

Clinical study participants must maintain particular medical parameters in order to continue to participate in the study. If he/she falls outside of these parameters, he/she cannot reenter the clinical study. After completion of a clinical trial, a government agency, such as the FDA, will approve or disapprove new treatments based on clinical trial results.

While evaluation is done to find and qualify individuals for clinical studies, current electronic systems do not exist to monitor and notify clinical study sponsors and treating clinicians that an existing clinical study participant is trending toward not meeting medical parameters of the clinical study.

### SUMMARY

Embodiments of the present invention proactively help to prevent the enrolled patients from falling out of clinical study, thereby reducing the cost incurred and on time completion of the trial. The embodiments address the primary challenge with clinical trials of retaining the patients. There is significant increase in cost and loss of time of clinical study to find replacements for patients who fall out of the study.

The claimed invention relates to a system and method supporting computerized healthcare information systems. More specifically, the claimed invention relates to a system and method for computer based healthcare information users to monitor medical parameters of patient and recommend suggestions so that a current clinical study participant does not fall out of the clinical failure for not meeting medical parameters required by the clinical study.

The claimed solution is necessarily rooted in computerized electronic medical record technology in order to overcome a problem specifically arising in the realm of computer healthcare information networks, and the claims address the problem of clinical study participants falling out of a clinical study in a computerized healthcare information system. If adhering to the routine, conventional function of clinical studies in a healthcare information system,

The claimed invention overcomes the limitations of current computer healthcare information technology and provides other benefits that will become clear to those skilled in the art from the foregoing description.

The claimed system and method of the present application represents a new paradigm of clinical study patient enrollment in a computerized electronic medical record. Not only does the claimed invention provide clinicians warnings a clinical study patient is at risk of falling out of the clinical study but it also provides health maintenance guidelines and recommendations for the patient could be used for patient care by modifying the patient's electronic medical record to make it more efficient, user friendly and cost-effective. The claimed invention also provides clinical study population trending information for medical parameters regarding all or a group of patients enrolled in a clinical study. Users of electronic medical records or electronic health records utilizing the claimed invention will notice improved performance of an electronic medical record and receive warnings and recommendations for patients enrolled in the clinical study. Furthermore, the warnings and recommendations for enrolled clinical patients will reduce the number of “clicks” or entries a computer user has to make in an EMR or EHR results in reducing the memory utilization, CPU cycles, number of operations that need to be performed by the computer, and power consumption. The resulting cost savings and operational efficiencies of a computer electronic medical record magnify the potential benefits of this technology.

With proactive health maintenance in place, appropriate treatment plans can be implemented to prevent the patients from reaching the established exclusion (For example, obesity: BMI Male >=35 and Female >=30 or Type 2 diabetes mellitus: HBA1C levels >9), thereby the patient will continue to be part of the study.

The health maintenance can be defined specific to obesity and Type 2 diabetes mellitus as per the study protocol. For example, if the study prohibits the use the generic diabetes mellitus treatment and recommends special drugs for diabetes patients with in this study it can be configured in present embodiments of the invention which in turn will be provided to the care providers to treat these study participants.

### BRIEF DESCRIPTION OF THE DRAWINGS

Embodiments are described in detail below with reference to the attached drawing figures, wherein:

FIG. 1 is a block diagram of an exemplary computing environment suitable to implement embodiments of the present invention;

FIG. 2 is an exemplary system architecture suitable to implement embodiments of the present invention; and

FIGS. 3-4 are flow diagrams depicting embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, systems, and computer-readable media for a system and method for computer based healthcare information users to monitor medical parameters of patient and recommend suggestions so that a current clinical study participant does not fall out of the clinical failure for not meeting medical parameters required by the clinical study.

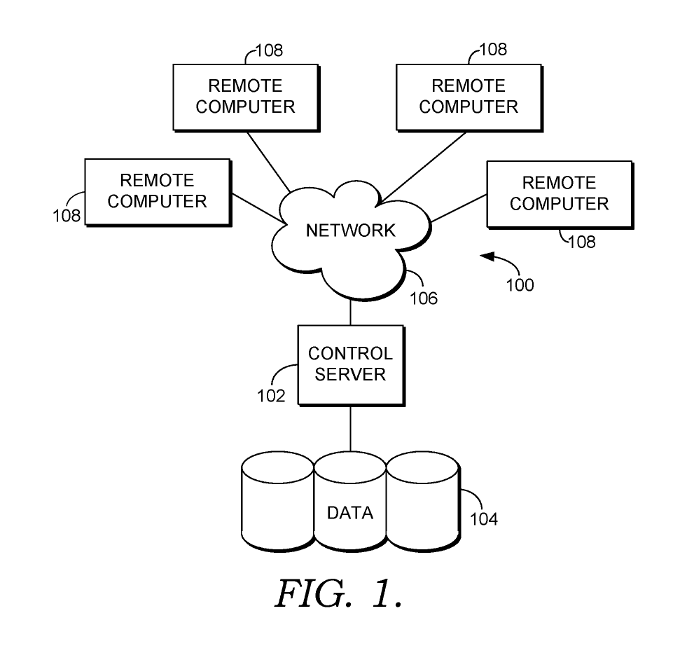

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention is a special computing system that can leverage well-known computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of non-transitory computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a microphone (e.g., voice inputs), a touch screen, a pointing device (commonly referred to as a mouse), a trackball, or a touch pad. Other input devices comprise satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

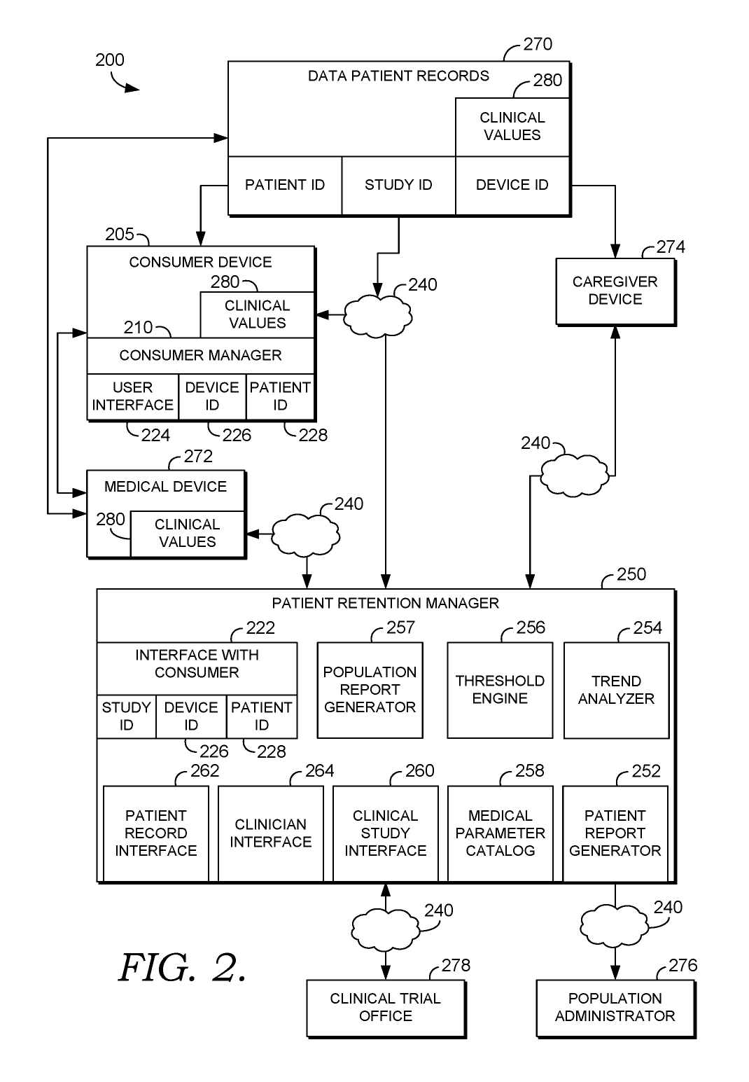

In an embodiment exhibited by FIG. 2, the processing duties are split among several computing systems. The data store 270 may be implemented through a database system and may be an electronic medical record or electronic health record. The network 240, such as the internet or other public or private network, serves as a communications link to consumer mobile devices 205, data store 270, medical devices 272, caregiver devices 274, population administrator devices 276, and clinical trial devices 278. The tasks performed by the processor utilize a variety of computer technology. In one embodiment, the technology can be divided into three tiers, web server, application server and database server. Each tier is comprised of a number of system layers as described below.

### Patient Retention Manager 250

Patient Retention Manager 250 is comprised of subcomponents including consumer interface 222, threshold engine 256, patient report generator, 252, population report generator 257, medical parameter catalog 258, clinical study interface 260, electronic medical record interface 262 and clinician interface 264. It will be appreciated that some or all of the modules of patient retention manager 250 may be accessed via network 240 and reside on or more devices remote to consumer device 205. Patient Retention Manager 250 can monitor some or all of the individuals enrolled in one or more clinical studies.

The patient retention manager 250 is also in communication with patient records 270, medical devices 272, caregiver devices 274, population administrator device 276 and clinical trial office device 278 via a network 240.

### Consumer Interface 222

Consumer interface 222 is in communication with consumer manager 210. Consumer manager 210 communicates information such as device id registration 226 and patient identification 228 to consumer interface 222 of patient retention manager 250. Consumer interface receives the patient identification 228 and device identification 226 for registration. Consumer interface 222 communicates threshold warnings and recommendations from the patient retention manager 250 to consumer manager 210 such that the information can be provided to the consumer via consumer interface 224 of consumer manager 210.

### Medical Parameter Catalog 258

The medical parameter catalog 258 maintains medical parameters for each clinical study. The medical parameters maintained include one or more of patient diagnosis, problems, active or previous medications, lab results, patient care results from nursing activities, past patient procedures, family history, social history, clinical events, future or planned order based activities and patient reported outcomes.

For example, the medical parameter catalog includes medical parameters and thresholds for patients enrolled in a clinical study. Clinical parameters are developed by the clinical trial advisory board to ensure that patient safety and medical guidelines are followed for the study. Exemplary clinical study A has 300 patients enrolled for a cardiovascular drug and includes medical parameter thresholds for the patients' BMI and high HBA1C levels. For clinical study A, patients with a BMI is greater than or equal to 35 for a male and greater than or equal to 30 for a female are excluded from participating in the clinical study. Furthermore, the medical parameters thresholds for a clinical study A may be set lower than the parameters that would disqualify a patient from enrollment or cause a patient to fall out of the study.

As such, the medical parameter threshold values in medical parameter catalog 258 would be thresholds for warnings that the patient is at risk of falling out of the study for having too high a BMI may be set lower, such that preventative measures may be taken to get the patient's BMI under control before he or she falls out of the clinical study. For example, the BMI threshold value for clinical study A is set 30 for males and 25 for females such that a threshold warning is issued to the patient's physician at device 274 and the clinical study team at device 278 such that measures can be implemented to keep the patient's BMI in the proper range so he/she is not excluded from the study.

In another example, an individual participating in clinical study A may be excluded if they have an HBA1C level >9 indicating Type 2 diabetes mellitus. As such, the HBA1C threshold value is set at >7.5 so that health maintenance recommendations and guidance are issued to the patient's physician at device 274 and the clinical study team at device 278 so that the individual does not fall out of the clinical study.

The clinical value 280 for a particular patient is received from one or more of patient records 270, consumer device 205, and/or medical device 272 for the clinical parameter. Threshold engine 256 determines whether the clinical value 280 exceeds the defined threshold value for the clinical parameter by accessing medical parameter catalog 258. Once a patient is enrolled in the study as study participant, data including clinical values from clinical visits (both trial visit and non-trial visit), Health Information Exchanges, medical records, user mobile devices and medical devices, will be evaluated against the defined threshold levels of medical parameters (Obesity and Type 2 diabetes mellitus) by the patient retention manager 250.

Medical parameter catalog 258 lists medical parameters, defined threshold value, and arranges them into catalogs according to clinical study. For example, for Clinical Study A, the medical parameters include:

Clinical Study A

### Diagnosis: Obesity

### Sex: Male

Threshold value: BMI >=30
Recommendations: Diet chart, workout regimen, follow-up visits scheduled, weight management counseling

Clinical Study A

### Diagnosis: Obesity

### Sex: Female

Threshold value: BMI >=25
Recommendations: Diet chart, workout regimen, follow-up visits scheduled, weight management counseling

Clinical Study A

### Diagnosis: Diabetes Mellitus

Threshold value: HBA1C levels >7.5
Recommendations: Prescription drugs, drug avoidance, diet protocol, schedule lab revisits

Threshold Engine 256 is configured to compare clinical values 280 received for the patient enrolled in the clinical study to compare against the defined threshold values in the medical parameter catalog 258. Defined threshold values may be numerical, existing/non-existing, positive or negative or text depending on the medical parameter. In clinical study A, threshold engine 256 determines if the clinical values received for the patient exceed the defined threshold value in medical parameter catalog 258 for clinical study A. If threshold engine 256 determines that the clinical values received for the patient do not satisfy the defined threshold values in medical parameter catalog 258, the threshold engine 256 continues to monitor medical values for the patient until the patient has completed the clinical study or has exceed one or more defined threshold values. If in clinical study A, an enrolled male patient has a BMI of 31, the threshold engine 256 will determine that the clinical value (BMI 31) has satisfied the defined threshold values in medical parameter catalog 258 for clinical study A and patient report generator 252 will issue a warning notification to the patient's treating clinician and clinical study clinicians and in some instances, include health recommendations for the patient.

Patient Report Generator 252

Patient Report Generator 252 issues health warnings and recommendations for a patient enrolled in a clinical study who has been determined by threshold engine 256 to satisfy defined threshold values. For example, system will provide an alert and/or the associated health maintenance plan for Obesity and Type 2 diabetes mellitus for patients who have satisfied the defined threshold values. The alert and/or associated health maintenance plan communicated by Patient Report Generator 252 via interfaces to configured alert recipients. The clinician interface 264 communicates the alert and/or associated health maintenance plan for the patient to patient's treating clinician device 274. The clinical study interface 260 communicates the alert and/or associated health maintenance plan to the clinical trial office device 278. The interface with consumer 222 communicates the alert and/or associated health maintenance plan to the user interface 224 of consumer device 205.

It will be appreciated that the alert and/or health maintenance plan can be communicated and displayed to clinicians, patients, clinical study team members (such as an investigator and/or coordinator) and patient care managers in a variety of ways including a message or message alert through an electronic medical record system such as Cerner Millennium, via e-mail or text message. Furthermore, the individual's electronic medical record is modified to reflect the alert and/or health maintenance plan. Furthermore, as described in more detail below, the individual's electronic medical record is modified to reflect is the member of a patient subpopulation of the clinical study for which they are enrolled.

The communication typically includes a customizable message for each satisfied medical parameter for a study including succinct and digestible information to educate the provider around what is at risk with the threshold being reached. For example, the notification may state that Patient 1's BMI has reached the threshold for the study and that Patient 1 is at risk of losing access to study including related preventative care, and investigational care, other benefits.

Trend Analyzer 254

The trend analyzer provides insight regarding critical medical parameters for the entire population of a clinical study to give information to the clinical trial office 278. For each of the patients enrolled in a clinical study, the trend analyzer logs, for each patient, when the clinical values for the patient have exceeded the defined threshold for the clinical parameter. The maintained log can be mined by the trend analyzer to provide clinical parameter trends for part or all of a patient population of a clinical study. For example, the trend analyzer 254 determines that about 40 to 50 percent of the enrolled patients are reaching the threshold of the parameters (for example, their BMI is above the defined threshold) and issues a report on this information to the study team device 278. The study team can use this information to take the mitigations to adjust the dosage of the drug in trial (prevent potential side effects) or stop the study without losing much time and cost.

If the trend analyzer 254 indicates to the trial team device 278 that about 10 percent of the enrolled patients are reaching the threshold of the parameters, then relook at the way that these patients are following the study protocol stringently or not. This will allow the study team to mitigate any problems with clinical parameters on time while completing the study trial on time. The trend analyzer 254 also provides insight to the clinical study team on the study progression even if there is no mitigation possible.

In one embodiment, a subpopulation record of patients in a clinical study is created by the trend analyzer 254. In one example, for Clinical Study A, a subpopulation record of patients enrolled in Clinical Study A have satisfied the medical parameters regarding Obesity (e.g., have reached a BMI value between 27-30). The trend analyzer 254 also creates a subpopulation record of patients enrolled in Clinical Study A for patients who have satisfied the medical parameter HBA1C of 7-7.5 indicating the potential for type 2 diabetes mellitus. The trend analyzer 254 can create the subpopulation records for a specific instance of time or over a given time period.

The above criteria can configured for a specific instance of time or over a given time period. The trend analyzer 254 generates a report for the trending information of the subpopulation from the subpopulation record and communicates the report to the clinical trial office device 278 and/or a population administrator device 276 who is responsible for the health of the population in general. For example, reports may be generated and communicated for Clinical Study A for the subpopulation trends for Obesity and Type 2 diabetes mellitus.

Population/aggregate threshold alerts would be sent to a centralized clinical trial office device 278. This way if the study is at risk for not maintaining its target accrual, it can be reviewed to determine if additional support is necessary or if the study will have to remain as risk with the potential for closure.

### Consumer Manager

Consumer manager 210 is the control center for consumers, such as patients or family members. Consumer manager 210 resides on a personal computing device or mobile device 205 (such a smart phone) of the consumer. Furthermore, consumer manager 210 has an interface 222 with device 205 such that consumer manager 210 can receive information input into to device 205.

The consumer manager 210 allows the consumer to communicate with patient retention generator 250 and patients' electronic medical records 270 via a network 240. The patient or patient representative may initiate registration of the device 205 via a web interface. The signup process will collect basic patient information, such as patient identification 228, device identification 226, a password and a unique user id which can be used to login. The patient identification 228 can be transmitted to patient records 270, such that the correct EMR for the patient is utilized.

### Patient Records 270

Patient Records Database 270 is computer store containing healthcare information for individual patients. Patient Records Database 270 includes an electronic version of patient records, such as an electronic medical record, including information for the patient, such as medication and infusion orders, tasks, images, examination reports, testing and lab results, medical history, diagnosis, medical values etc. Patient Records Database 270 contains the standard medical and clinical data gathered in a provider's office. A Patient Records Database 270 is a digital or computerized version of a paper chart that contains all of a patient's medical history. In the embodiments of the present invention, the patient identifier 228 and patient device identifier 226 are stored in the EMR for the individual patient. Additional information, such has clinical trial information, may also be stored in the patient's EMR.

### Medical Devices 272

Medical device 272 might include cardiac monitors, ventilators, balloon pumps, patient beds, infusion pumps, sequential-compression devices, electronic security devices, and vital-sign detecting devices, lab devices, medication administration devices, blood transfusion devices and any device that generates medical information for a patient. Medical device 210 may generate various data (e.g., measured heart rate) that, as described in more detail below, is communicated to the patient retention manager 250.

Clinician Device 274

Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, students, office assistants and the like. The remote computers may also be physically located in nontraditional medical care environments so that the entire health care community may be capable of integration on the network. The remote computers may be personal computers, servers, routers, network PCs, peer devices, other common network nodes, or the like, and may include some or all of the components described above in relation to the server. The devices can be smart phones, personal digital assistants or other like devices.

### System Flow

The patient retention manager as a clearinghouse for medical parameter values of patients enrolled in a clinical study. The patient retention manager provides warnings and recommendations to clinicians treating patients in a clinical study. The system maintains a real-time interface with the patient's records, treating clinicians, the clinical study team, medical devices of the patient and the patient's consumer device to track the medical parameter values for the patient participating in a clinical study. The transaction flow 300 for the clinician, clinical study team, medical devices, patient and patient records is directly related to the structure of the underlying patient retention manager and databases.

At step 305, clinical study identification and the medical parameters and defined threshold values for the parameters are received. For example, for clinical study A the medical parameters and defined threshold values for obesity and diabetes are built in the patient retention manager. The medical parameters and defined threshold values are stored in the medical parameter catalog database.

At step 310, health maintenance and warning information is built for each of the medical parameters and defined threshold value. For example, health maintenance plans such is weight loss and smoking cessation may be recommended if a patient medical parameter value meets a defined threshold value. The health maintenance and warning information is stored in the medical parameter catalog database.

At step 315, the patient is registered with the patient retention manager. For example, patient records may transmit the patient's medical record number or other identifier which is stored in the patient retention manager.

At step 320, the clinician, medical devices of the patient and user devices are registered with the patient retention manager. In one embodiment, the consumer activates link to consumer manager which in turn activates and registers consumer and consumer's device with the patient retention manager and patient's EMR. This activation is typically accomplished by logging into consumer manager by the consumer. Typically, clinicians and medical devices are registered with patient records and this information is communicated to the patient retention manager for providing the warnings.

At step 325, the patient is correlated with one more clinical studies. For example, after receiving a notification of a patient enrolling in clinical study A, the patient's MRN is correlated and stored in conjunction with clinical study A.

At step 340, medical parameter values are received for a patient enrolled in a clinical study. The values may be received by the patient retention manager from the patient records, medical device or consumer device.

At step 345, the medical parameter values received for the patient are compared by the patient medication manager to the defined threshold values in the medical parameter catalog. If the medical parameter values for the patient do not satisfy the defined threshold value, the patient medication manager will continue to evaluate medical parameter values received for the patient but will does not issue an alert or health maintenance recommendations.

At step 350, if the medical parameter values received for the patient satisfy the defined threshold values, the alert and health maintenance recommendations are accessed from the medical parameter catalog. The alerts and/or health maintenance recommendations are communicated to the treating clinician, clinical study team, population manager and/or patient at the user device at step 360.

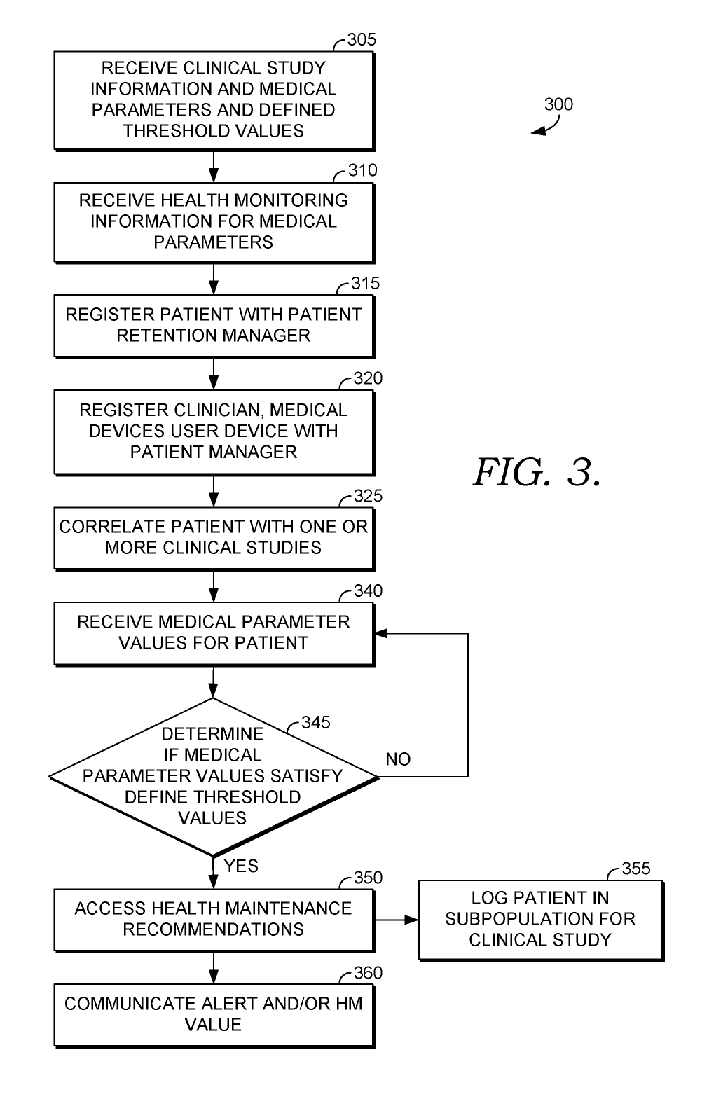

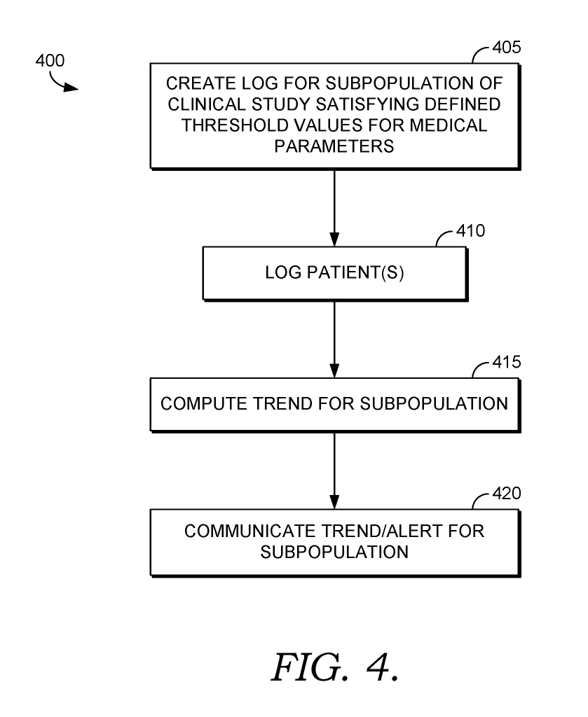

At 355, the patient is logged by trend analyzer in a subpopulation record for the clinical study who has satisfied defined threshold values. This information is used by the trend analyzer, the method of which is described in more detail with reference to FIG. 4. The patient retention manager is scalable and is capable of performing the steps of FIG. 3 for many patients enrolled in multiple clinical studies

FIG. 4 depicts the steps 400 of trend analyzer of the patient retention manager. At step 405, a log is created by the trend analyzer for patients who have satisfied defined threshold values for medical parameters for a clinical study for which they are enrolled. At step 410, patients are logged by the trend analyzer as they satisfy the defined threshold values for their clinical study (e.g., step 355 of FIG. 3). These can be done for multiple patients in a clinical study. Furthermore the patient retention manager manages the defined threshold values for multiple clinical studies.

At step 415, the trend analyzer computers trends for the logged subpopulation. For example, the trend analyzer computes the percentage of patients who have satisfied defined threshold values for medical parameters for the study period or for a defined period in the study. At step 420, the trending information for the subpopulation is communicated to the clinical team and population manager to determine if changes need to be made to the study or if there are trending health issues that may be related to the clinical study so that remedial measures can be made if necessary.

The present invention has been described in relation to particular embodiments, which are intended in all respects to be illustrative rather than restrictive. Further, the present invention is not limited to these embodiments, but variations and modifications may be made without departing from the scope of the present invention.

1. A system useful in a computer healthcare system for creating a database for medical parameter trends for multiple individuals in a clinical study, the system comprising:
(a) a computer store containing data, for each of a plurality of medical parameters for a clinical study and identification of multiple individuals enrolled in a clinical study;
(i) wherein each of the plurality of medical parameters for a clinical study includes at least one of diagnosis, medications, lab results, care results from nursing activities, medical procedures, demographic information, clinical events and patient reported outcomes;
(ii) wherein the identification of each individual includes an identification code for each of the individual;
(b) a computer server at the healthcare information system, which computer server is coupled to the computer store and programmed to:
(i) receive at least one signal from patient records, user device or medical device, one or more values for the medical parameters for each of the individuals;
(ii) automatically identify the identification code of each individual from the at least one signal;
(iii) automatically identify from the computer store a clinical study that each individual is enrolled;
(iv) automatically accessing the computer store for the plurality of medical parameters for the identified clinical study that each individual is enrolled;
(iii) automatically identify each individual's value from the at least one signal for one or more of the plurality of medical parameters for the clinical study;
(v) automatically determining whether each individual's value from the at least one signal satisfies a pre-defined criteria for the one or more of the plurality of medical parameters for the clinical study each individual is enrolled;
(vi) creating a database record for listing each individual enrolled in the clinical study who has satisfied the pre-defined criteria and which of the pre-defined criteria is satisfied the clinical study; and
(vii) modifying the database record listing when each individual enrolled in the clinical study satisfies the pre-defined criteria and which of the pre-defined criteria is satisfied by each individual the clinical study using (b)(i-iv).

2. The system of claim 1, further comprising:
generating and serving to a clinical study administrator computing device the database record listing of each enrolled individual in the study who satisfied the pre-defined criteria and which of the pre-defined criteria was satisfied by each individual.

3. The system of claim 1, further comprising:
automatically generating a visually perceptive notification of a warning notification for each individual's value that satisfies the pre-defined criteria for the one or more of the plurality of medical parameters for the clinical study that each individual is enrolled; and
serving to one or more clinicians for each individual the warning notification.

4. The system of claim 3, further comprising:
accessing an electronic health record for each individual.

5. The system of claim 4, further comprising:
modifying the electronic health record for each individual to reflect that each individual's value satisfies the pre-defined criteria for the one or more of the plurality of medical parameters for the clinical study each individual is enrolled.

6. The system of claim 5, further comprising:
modifying the electronic health record for each individual to reflect the health maintenance medical recommendations for each individual if the individual's value satisfies the pre-defined criteria for the one or more of the plurality of medical parameters for the clinical study each individual is enrolled.

7. The system of claim 1, further comprising:
generating a subpopulation record for individuals who satisfy the pre-defined criteria for the one or more of the plurality of medical parameters for the clinical study.

8. The system of claim 7, further comprising:
modifying the subpopulation record to include each individual who has satisfied the pre-defined criteria.

9. The system of claim 8, further comprising:
modifying an electronic medical record for each individual to identify them as being members of the subpopulation record.

10. The system of claim 1, wherein the computer store contains the database record for listing each individual enrolled in the clinical study who has satisfied the pre-defined criteria and which of the pre-defined criteria is satisfied for the clinical study.

11. One or more computer storage media having computer-usable instructions that, when used by one or more computing devices, cause the one or more computing devices to perform a method for creating a database for medical parameter trends for multiple individuals in a clinical study, the media comprising:
receiving at least one signal from patient records, user device or medical device, one or more values for the medical parameters for each of the individuals; automatically identifying the identification code of each individual from the at least one signal;
automatically identifying from a computer store a clinical study that each individual is enrolled;
automatically accessing the computer store a plurality of medical parameters for the identified clinical study that each individual is enrolled;
automatically identifying each individual's value from the at least one signal for one or more of the plurality of medical parameters for the clinical study;
automatically determining whether each individual's value from the at least one signal satisfies a pre-defined criteria for the one or more of the plurality of medical parameters for the clinical study each individual is enrolled;
creating a database record for listing each individual enrolled in the clinical study who has satisfied the pre-defined criteria and which of the pre-defined criteria is satisfied the clinical study; and
modifying the database record listing when each individual enrolled in the clinical study satisfies the pre-defined criteria and which of the pre-defined criteria is satisfied by each individual the clinical study.

12. The media of claim 11, further comprising:
generating and serving to a clinical study administrator computing device the database record listing of each enrolled individual in the study who satisfied the pre-defined criteria and which of the pre-defined criteria was satisfied by each individual.

13. The media of claim 11, further comprising:
automatically generating a visually perceptive notification of a warning notification for each individual's value that satisfies the pre-defined criteria for the one or more of the plurality of medical parameters for the clinical study that each individual is enrolled; and
serving to one or more clinicians for each individual the warning notification.

14. The media of claim 13, further comprising:
accessing an electronic health record for each individual.

15. The media of claim 14, further comprising:
modifying the electronic health record for each individual to reflect that each individual's value satisfies the pre-defined criteria for the one or more of the plurality of medical parameters for the clinical study each individual is enrolled.

16. The media of claim 15, further comprising:
modifying the electronic health record for each individual to reflect the health maintenance medical recommendations for each individual if the individual's value satisfies the pre-defined criteria for the one or more of the plurality of medical parameters for the clinical study each individual is enrolled.

17. The media of claim 11, further comprising:
generating a subpopulation record for individuals who satisfy the pre-defined criteria for the one or more of the plurality of medical parameters for the clinical study.

18. The media of claim 17, further comprising:
modifying the subpopulation record to include each individual who has satisfied the pre-defined criteria.

19. The media of claim 18, further comprising:
modifying an electronic medical record for each individual to identify them as being members of the subpopulation record.

20. The media of claim 11, wherein the computer store contains the database record for listing each individual enrolled in the clinical study who has satisfied the pre-defined criteria and which of the pre-defined criteria is satisfied for the clinical study.
